(19) United States
(12) Patent Application Publication
(10) Pub. No.: US 2009/0284104 A1
(43) Pub. Date: Nov. 19, 2009

(54) BUILT-IN MOTOR, IN PARTICULAR A BUILT-IN TORQUE MOTOR

(75) Inventors: Markus Knorr, Augsburg (DE); Gerhard Matscheko, Starnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/295,461

(22) PCT Filed: Feb. 20, 2007
(86) PCT No.: PCT/EP2007/051611

§ 371 Date: May 26, 2009

(30) Foreign Application Priority Data
Mar. 31, 2006 (DE) 10 2006 015 065.1

(51) Int. Cl. H02K 11/00

(52) U.S. Cl. 310/68 B

(57) ABSTRACT

The invention relates to a built-in motor (1), in particular to a built-in torque motor, having a rotor (2) and a stator (3), with the built-in motor (1) having a positioning apparatus for positioning at least one transmitter (5), and/or having at least one transmitter (5).

The invention relates to a built-in motor, in particular to a built-in torque motor without its own bearing.

Built-in motors are motors which are delivered as built-in components. Additional parts, for example a bearing and a rotation transmitter, are required for a complete drive unit. In particular, built-in motors do not have their own bearing and have no shaft, since the part to be moved, that is to say the rotor, of the built-in motor is intended for flange-connection to a shaft.

Torque motors are three-phase synchronous motors with permanent-magnet excitation and a large number of poles. The torque is generally achieved by a stationary stator which transmits the torque directly to the rotor via the air gap. In this drive concept, there are no mechanical transmission elements such as a gearbox and it therefore also avoids the inaccuracies resulting from a mechanism. In addition, the torque motor offers virtually wear-free and maintenance-free operation.

Torque motors are particularly suitable for machine tools with round tables or pivoting axes, that is to say by way of example high-speed cutting machining centers or in shape milling with pivoting heads in large machining centers. Furthermore, they can be used as drives for high-speed shafts in turning machines, for dynamic machine tools in machining centers, in robotics and for plastic injection machines.

Particularly in the case of direct drives in the form of torque motors, the need to additionally integrate kinematic sensors for control purposes results in association problems during design and assembly. For example, in the case of angle measurement systems using absolute information for commutation, it is not only possible to select the wrong position sensor but also to position it incorrectly during assembly. This leads to commissioning delays, faults during operation resulting in inadequate motor performance, or even damage. A further program can result from the lack of an adjustment capability or maladjustment of the sensors.

The sensor system for kinematic variables which has not previously been integrated until now in built-in torque motors without bearings prevents these drives from being used in applications which already have a machine-end bearing. Although in principle built-in motors without their own bearing are optimally suitable for these applications, motors with an integrated sensor system for detection of kinematic variables are, however, constructed only with their own bearing, for accuracy reasons. Until now, the task of sensor integration when using built-in torque motors has therefore had to be coped with by the machine designer.

The object of the present invention is to provide a built-in motor, in particular a built-in torque motor, which has integrated transmitters and/or sensors for detection of kinematic variables.

The object is achieved by the features of patent claim 1. Advantageous developments are specified in the dependent claims.

The built-in torque motor has a rotor, a stator and a transmitter and/or a positioning apparatus for positioning of at least one transmitter.

The stator preferably has a mounting flange, and the positioning apparatus is arranged on the mounting flange. Since this is a built-in motor, which generally has a mounting flange for flange-connection of the motor to a machine, for example a printing machine or machine tool, the positioning apparatus can be integrated in the mounting flange. The integration of the transmitter in the mounting flange of the stator or in the stator results in the transmitter at the same time being protected, for example, against dirt or else against destruction while the built-in motor is being installed. However, the positioning apparatus can also be arranged on the stator, for the situation in which the mounting flange is arranged on the machine. The stator and the mounting flange can likewise be formed integrally.

A measurement track is advantageously arranged on the rotor or on a rotor flange. The rotor and rotor flange can also be formed integrally. The measurement track represents the measurement surface of the measurement object which the transmitter scans. The measurement track is arranged such that accurate axial position, roundness and centering are ensured as appropriate for the transmitter being used.

The mounting flange of the stator or the rotor flange, or alternatively also corresponding intermediate flanges, are designed such that they have centering collars, as a result of which the stator and rotor can be placed on and screwed to centering collars which must be provided on the machine side and are close to the machine bearing, matching the centering collars on the mounting flange of the stator and on the rotor flange.

The arrangement of the transmitter in the mounting flange of the stator or in a connecting flange between the motor and the machine allows the roundness accuracy of the machine bearing to be mapped directly onto the running accuracy of the transmitter. To this end, the centering collars on the motor-side flanges and on the machine side must be designed with an adequately accurate fit for the roundness accuracy required by the transmitter. In the situation where an absolute embodiment is required, this is adjusted to the required accuracy with respect to the magnet positions of the rotor in order, for example, to ensure the commutation of the motor.

The positioning apparatus is preferably in the form of a recess, in particular in order to at least partially hold the transmitter. For this purpose, a recess in the form of one or more holding receptacles is provided in the mounting flange on the stator or in the stator, and these are used to fix one or more transmitters that are used, accurately in position. The transmitter or the transmitters, or the corresponding transmitter holder, is or are in this case pushed into the holding receptacles radially from the outside and therefore allows or allow radial guidance with respect to the motor axis, therefore offering a degree of freedom for adjustment of the distance required between the transmitter and the measurement track. For the situation in which an absolute embodiment is required, the transmitters are aligned with defined accuracy with respect to the motor winding, thus ensuring correct commutation of the motor. The positioning apparatus for the transmitter may, however, be, for example, in the form of a screw or a tongue-and-groove joint.

The positioning apparatus and/or the transmitter preferably have/has a stop for adjustment of the distance between the transmitter and the measurement track. An optimum setting of the distance, determined on an “ideal shaft” during motor production, is defined in advance by this stop on the motor flange on the stator or of the stator. After installation of the actual motor, the transmitter or the transmitter holder is positioned and locked on this stop for transmitter adjustment, via an operating mechanism, for example by radial pressure against a hold-back spring. For later removal of the motor, the transmitter or the transmitter holder is simply pushed back radially from the rotor by releasing the operating mechanism and the spring force, with the operating mechanism being designed such that this must be done before motor removal, thus preventing the transmitter from being damaged during removal. The lock is provided by a considerably stiffer spring or by a force limiting element and is designed, in the event of a collision occurring between the measurement track and the transmitter, such that the transmitter and the measurement track are not destroyed, but rather the transmitter is pushed back. By way of example, contact surfaces with an emergency running characteristic can be provided parallel to the transmitter and measurement track for this purpose and make contact before the actual measurement surfaces of the transmitter.

A distance sensor is preferably provided for adjustment of the transmitter. The distance sensor is additionally used for adjustment of the transmitter, particularly in the situation in which the adjustment by means of the stop as described above is inadequate. The distance sensor measures the distance or the air gap between the transmitter and the measurement track, with the signal from the distance sensor being shown on a display, for fine adjustment. If the distance is not correct, then it can be adjusted for example by means of a mechanism for movement of the stop.

The adjustment of the positioning apparatus or of the transmitter by means of the stop in principle, per se, allows the motor to be operated. The fine adjustment by means of the distance sensor is used to optimize the measurement accuracy of the transmitter.

The transmitter is preferably a position transmitter. However, further transmitters or sensors, for example acceleration transmitters, velocity transmitters or temperature sensors, may also be provided, in which the plurality of sensors can be arranged in one or more positioning apparatuses. The built-in motor may therefore also have one or more positioning apparatuses.

The stator preferably has integrated cooling. The transmitters and sensors are likewise cooled by the cooling of the stator, which is provided in any case because the stator needs to be cooled. The cooling function for the transmitters and sensors is used in particular for measurement principles in which a power loss occurs or else rotor losses in the motor result in heating of the measurement elements.

The connection technique for the motor and all the sensor systems for operation of the motor, in which case temperature sensors may also be provided, is preferably integrated in the positioning apparatus and therefore in the built-in motor, with an appropriate sensor and data interface being provided for digital transmission of the transmitter and sensor signals, and motor type identification (electronic rating plate).

In the case of measurement principles which are sensitive to stray magnetic fields, it is likewise also possible to integrate materials which attenuate eddy currents and provide magnetic shielding, between transmitter and/or sensor components, and motor components.

The built-in motor according to the invention offers a solution for simple and safe installation and adjustment of a built-in motor and transmitter and/or sensor components, by minimizing the number of mechanical interfaces. The correct adjustment of the transmitters and sensors is fixed even before installation of the motor, and can be carried out by a very simple operation during installation or servicing. Furthermore, the arrangement of the transmitters and sensors on the built-in motor avoids the possibility of subsequent installation errors. In addition, the built-in motors can be checked for functionality complete with the transmitter and sensors separately, before installation.

Further features and details of the invention will be explained in more detail using exemplary embodiments and in conjunction with the attached drawings, in the following description. In this case, features and relationships described in individual variants can in principle be transferred to all the exemplary embodiments. In the drawings:

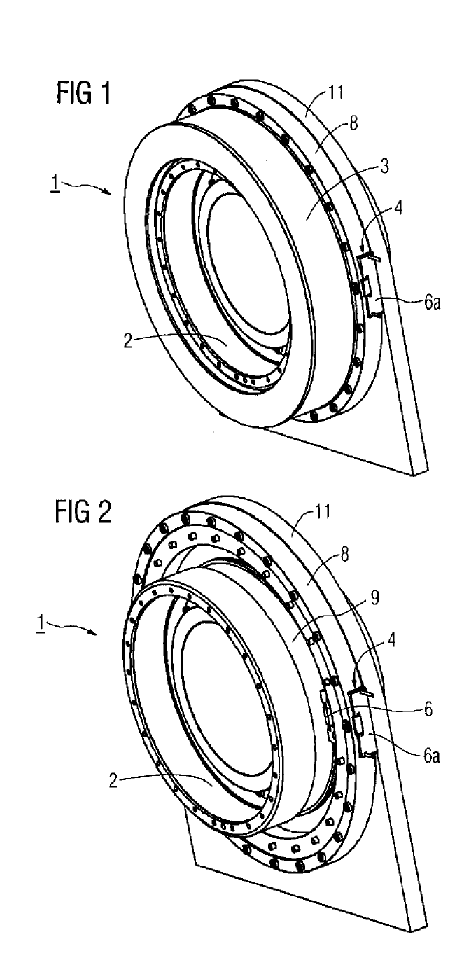

FIG. 1 shows a perspective view of a built-in motor according to the invention,

FIG. 2 shows a first perspective partial view of the built-in motor according to the invention shown in FIG. 1;

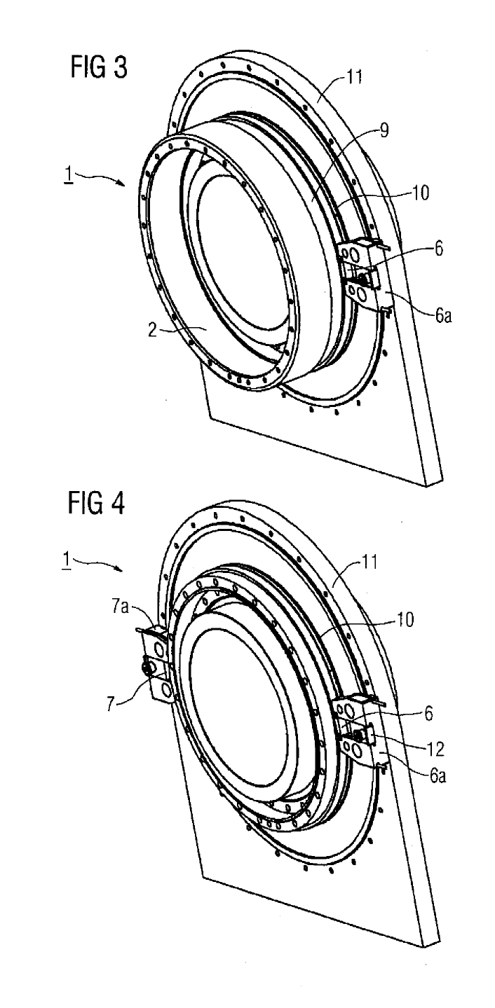

FIG. 3 shows a second perspective partial view of the built-in motor according to the invention shown in FIG. 1;

FIG. 4 shows a third perspective partial view of the built-in motor according to the invention shown in FIG. 1;

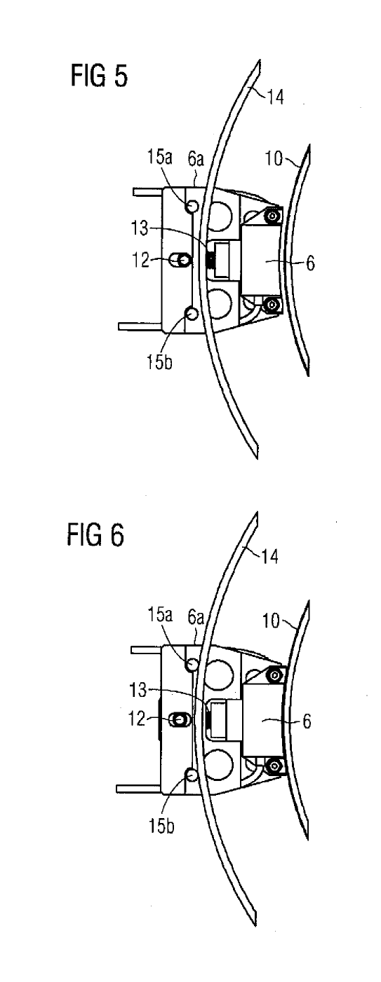

FIG. 5 shows a first partial view from the side of the built-in motor according to the invention shown in FIG. 1; and

FIG. 6 shows a second partial view from the side of the built-in motor according to the invention shown in FIG. 1.

FIG. 1 shows a perspective view of the built-in motor 1 according to the invention as well as parts of a machine 11, for example a printing machine, from the front. The built-in motor 1 has already been partially flange-connected to the machine 11. The built-in motor, which in particular is in the form of a built-in torque motor, has a rotor 2, a stator 3 and a first transmitter 6, which is not shown but is located in the transmitter holder 6a. The stator 3 has the mounting flange 8, and the positioning apparatus 4 is arranged on the mounting flange 8. The positioning apparatus 4 and the transmitter holder 6a could, however, just as well also be arranged on the stator 3.

FIG. 2 shows a first perspective partial view of the built-in motor 1 according to the invention from FIG. 1. As can be seen particularly well in FIG. 2, the positioning apparatus 4 is in the form of a recess. For this purpose, a recess in the form of a holding receptacle is provided in the mounting flange 8 of the stator 3 and is used to fix the transmitter 6 accurately in position. The transmitter 6 has the transmitter holder 6a which is pushed into the positioning apparatus 4 or recess radially from the outside.

FIG. 3 shows a second perspective partial view of the built-in motor 1 according to the invention from FIG. 1. This partial view shows the measurement track 10 which is arranged on the rotor flange 9. The measurement track 10 could likewise be arranged on the rotor 2. The measurement track 10 represents the measurement surface of the measurement object, that is to say of the rotor 2, which the transmitter 6, which is located in the transmitter holder 6a, scans. The transmitter holder 6a has the operating mechanism 12 for adjustment and locking of the transmitter 6 with the transmitter holder 6a.

FIG. 4 shows a third perspective partial view of the built-in motor 1 according to the invention from FIG. 1. As can be seen from FIG. 4, a plurality of transmitters and/or position devices can be provided on the built-in motor 1. The first transmitter 6 is, for example, a position transmitter, and the second transmitter 7 is, for example, an acceleration sensor. The two transmitters 6 and 7 have the transmitter holders 6a and 7a and are respectively arranged in a separate positioning apparatus 4 and 5, with the positioning apparatuses 4 and 5 being arranged opposite, as a recess in the mounting flange 8 of the stator 3.

FIG. 5 shows a first partial view from the side of the built-in motor 1 according to the invention from FIG. 1. The transmitter holder 6a has the operating mechanism 12 with the hold-back spring 13, by means of which the transmitter 6 in the transmitter holder 6a is adjusted and locked on the stop 15. The stop 15 is formed by the two pins 15a and 15b which, when in the operating state or locked state, rest on the machine-side centering collar 14 for the stator 3. FIG. 5 shows the unlocked position of the transmitter holder 6a, which is characterized by a safety separation between the transmitter 6 and the measurement track 10.

FIG. 6 shows a second partial view from the side of the built-in motor 1 according to the invention from FIG. 1. FIG. 6 shows the operating state or locked state of the transmitter holder 6a with the transmitter 6. The two stop pins 15a and 15b rest on the machine-side centering collar 14 for the stator 3.

1.-12. (canceled)

13. A built-in motor, in particular a built-in torque motor, comprising:
a rotor;
a stator interacting with the rotor;
a transmitter for determining a kinematic variable of the rotor; and
a positioning apparatus in the form of a recess provided in the stator for positioning the transmitter.

14. The built-in motor of claim 13, wherein the stator has a mounting flange, said positioning apparatus being arranged on the mounting flange.

15. The built-in motor of claim 13, wherein the rotor or a rotor flange has a measurement track.

16. The built-in motor of claim 14, wherein the rotor has a rotor flange, said mounting flange of the stator and said rotor flange having centering collars.

17. The built-in motor of claim 15, wherein at least one member selected from the group consisting of positioning apparatus and transmitter has a stop for defining a distance between the transmitter and the measurement track.

18. The built-in motor of claim 15, further comprising a distance sensor measuring a distance between the transmitter and the measurement track for adjustment of the transmitter.

19. The built-in motor of claim 13, wherein the transmitter is a position transmitter.

20. The built-in motor of claim 13, further comprising at least one further such transmitter.

21. The built-in motor of claim 20, wherein the further transmitter is an acceleration transmitter.

22. The built-in motor of claim 13, wherein the further transmitter is a velocity transmitter.

23. The built-in motor of claim 13, further comprising a cooling system integrated in the stator for cooling the transmitter.

24. The built-in motor of claim 13, further comprising a sensor/transmitter interface and data interface provided for digital transmission of transmitter and/or sensor signals and motor type identification.
